(19) United States
(12) Patent Application Publication
(10) Pub. No.: US 2026/0351232 A1
(43) Pub. Date: Nov. 5, 2026

(54) EAR CANAL NOISE REDUCTION COMPENSATION SYSTEM, EAR CANAL NOISE REDUCTION COMPENSATION METHOD THEREOF AND COMPUTER PROGRAM PRODUCT

(71) Applicant: REHEAR AUDIOLOGY COMPANY LTD., Taipei City (TW)

(72) Inventors: Ying-Hui LAI, Taipei City (TW); Ming-Han Yeh, Taipei City (TW)

(73) Assignee: REHEAR AUDIOLOGY COMPANY LTD., Taipei City (TW)

(21) Appl. No.: 19/282,018

(22) Filed: Jul. 28, 2025

(30) Foreign Application Priority Data
Apr. 30, 2025 (TW) 114116403

(51) Int. Cl. G10K 11/178

(52) U.S. Cl. CPC G10K 11/17825; G10K 11/17875; G10K 2210/1081; G10K 2210/3026; G10K 2210/3028

(57) ABSTRACT

An ear canal noise reduction compensation system includes a loudspeaker driven by an audio signal to transmit sound to an ear canal, an error microphone receiving a reflected sound from the ear canal to convert the reflected sound into an electrical signal, a wireless transceiver module receiving the electrical signal, and an electronic device receiving the electrical signal via a wireless transmission network. The electronic device calculates a difference in sound wave energy between the error microphone and an eardrum based on the electrical signal and artificial intelligence, generates compensating filter parameters associated with the ear canal based on the difference in the sound wave energy, transmits the compensating filter parameters to a feedback filter by means of the wireless transmission network and the wireless transceiver module, and generates compensating energy in a frequency response of reverse waves in the ear canal by means of the compensating filter parameters.

### BACKGROUND

### 1. Technical Field

The present disclosure relates to an audio compensation technology, and more particularly, to an earphone device, an ear canal noise reduction compensation system, a method thereof, and a computer program product that automatically compensate for the energy of reverse waves at various frequency bands.

### 2. Description of Related Art

With the continuous evolution of earphones, a variety of different internal driver units have also been developed. Although there have been no major changes in the underlying principle, the structures for generating sound are actually quite different, and each type of sound generating structure has its own developing background, but also has its own advantages and disadvantages.

The research studies have pointed out that different gains of frequency response used by an audio processing chip would directly affect the user's experience of listening to sound or music. Currently, the frequency response of true wireless stereo (TWS) earphones all uses the digital signal processing (DSP) unit to perform the compensation processing of each frequency band, and the precision of the frequency adjustment are affected by the sampling frequency of the DSP unit (that is, the higher the sampling rate is, the finer or the more precise the frequency adjusting ability is). However, when the sampling rate is increased, the power consumption of the DSP chip is also increased, such that the user's usage time under the same battery power is greatly reduced.

In addition, when conducting a real-ear measurement, it is necessary to insert the probe near the tympanic membrane (e.g., the tip of the probe is about 5 mm away from the tympanic membrane) to confirm how much sound can really be heard in the ear canal and the quality of the sound in the ear canal. However, measurement by insertion of a probe requires the assistance of a professional (e.g., a professional tuner), which is extremely inconvenient.

Moreover, if an active noise cancellation (ANC) framework is used to adjust the compensating parameters, it is conventionally necessary to dynamically adjust multiple filters (e.g., filter type, fc, fc1, Q) or filter coefficients (e.g., b₀, b₁, b₂ . . . a₀, a₁ . . . ) to obtain a frequency response for filter parameter compensation. If the frequency response is obtained by dynamically adjusting the filter coefficients, there will be a very high dimension that needs to be adjusted, making the filter coefficients for generating the reverse wave hard to be quickly and accurately set.

Further, the feedback (FB) filters used in current active noise cancellation chips only eliminate ambient noise in the ear canal, without taking into account the characteristics of the user's ear canal to appropriately adjust the energy and frequency response of the reverse wave and to enhance the effect of noise reduction in the ear canal, i.e., to effectively reduce the leakage noise in the ear canal and interference caused by the own voices.

The above are some of the main problems encountered in the current technical field. Accordingly, in view of the above reasons, how to provide an earphone device and ear canal noise reduction compensation technology that do not require a probe tube transducer (i.e., a probe tube microphone), do not need to be confined to a professional hearing space (e.g., audiological testing room) for conducting the real-ear measurement and analysis, and do not need the assistance of professionals (e.g., professional tuners) for effectively solving the abovementioned problems has become an urgent issue for the industry to solve.

Furthermore, there is a need to effectively reduce the power consumption and latency of the DSP chip and to provide accurate, real-time, automated and customized user earphone devices (e.g., commercially available earphones, ANC earphones, TWS earphones, hearing aids, auditory aids, or earphones and glasses with hearing aid functions, etc.) for users in the current real environment, and how to greatly reduce the dimensions that need to be adjusted to quickly and accurately set filter compensation coefficients of the feedback filters of the earphone devices and ear canal noise reduction compensation technology has become an urgent issue for the industry to solve.

### SUMMARY

In view of the aforementioned shortcomings of the prior art, the present disclosure provides an ear canal noise reduction compensation system, which comprises: a loudspeaker driven by an audio signal to transmit sound to a user's ear canal; an error microphone receiving a reflected sound from the user's ear canal to convert the reflected sound into an electrical signal; a wireless transceiver module receiving the electrical signal converted from the error microphone; and an electronic device receiving the electrical signal transmitted from the wireless transceiver module via a wireless transmission network, wherein the electronic device calculates a difference in sound wave energy between the error microphone and an eardrum in the user's ear canal based on the electrical signal and artificial intelligence technology, generates compensating filter parameters associated with the user's ear canal based on the difference in the sound wave energy, transmits the compensating filter parameters to a feedback filter by means of the wireless transmission network and the wireless transceiver module, and generates compensating energy in a frequency response of reverse waves in the user's ear canal by means of the compensating filter parameters.

The present disclosure further provides an ear canal noise reduction compensation method, which comprises: transmitting sound to a user's ear canal by means of a loudspeaker driven by an audio signal; receiving a reflected sound from the user's ear canal by an error microphone to convert the reflected sound into an electrical signal; receiving the electrical signal converted from the error microphone by a wireless transceiver module connected to the error microphone; and receiving the electrical signal transmitted from the wireless transceiver module by an electronic device via a wireless transmission network, wherein the electronic device calculates a difference in sound wave energy between the error microphone and an eardrum in the user's ear canal based on the electrical signal and artificial intelligence technology, generates compensating filter parameters associated with the user's ear canal based on the difference in the sound wave energy, transmits the compensating filter parameters to a feedback filter by means of the wireless transmission network and the wireless transceiver module, and generates compensating energy in a frequency response of reverse waves in the user's ear canal by means of the compensating filter parameters.

The present disclosure further provides a computer program product implementing the aforesaid ear canal noise reduction compensation method.

The present disclosure also provides a non-transitory computer-readable recording medium, that stores instructions and is executed by a processor and/or memory using computing apparatus or a computer to perform the aforesaid ear canal noise reduction compensation method when executing the non-transitory computer-readable recording medium.

In an embodiment, the audio signal is a transparency audio signal or a streaming audio signal.

In an embodiment, the audio signal is an audio signal with a frequency of 3 KHz or less (i.e., 0 Hz to 3 KHz).

In an embodiment, the feedback filter includes a storage module, and the compensating filter parameters are stored in the storage module.

In an embodiment, the feedback filter is a feedback filter module for active noise cancellation.

In an embodiment, the compensating filter parameters are transmitted to and stored in a device or an apparatus having audio processing capability via the wireless transmission network, and the device or the apparatus generates the compensating energy in the frequency response of the reverse waves in the user's ear canal by means of the compensating filter parameters.

In an embodiment, the ear canal noise reduction compensation system performs real-time and/or synchronous processing via an earphone device and an application program of the electronic device in conjunction with wireless communication technology.

Accordingly, the present disclosure does not require a probe tube transducer (i.e., a probe tube microphone), does not need to be limited to a professional hearing space when conducting a real-ear measurement analysis, and does not need the assistance of a hearing professional for effectively addressing the aforementioned problems of the prior art. Further, the present disclosure can use a user's earphone device and an electronic device to perform compensating filter parameters of a feedback filter in each frequency under the current real environment via wireless communication technology, can provide accurate, real-time, automated, and customized user's earphone device, and greatly reduces the dimensions that need to be adjusted in order to set the coefficients of the compensating filter parameters of the feedback filter quickly and accurately.

### BRIEF DESCRIPTION OF THE DRAWINGS

FIG. 1 is a schematic block diagram showing an ear canal noise reduction compensation system and an ear canal according to the present disclosure.

FIG. 2 is a schematic diagram showing an earphone device combined with an electronic device (e.g., a smart device) according to an embodiment of the present disclosure.

FIG. 3 is a schematic diagram showing reverse waves with and without consideration of ear canal characteristics according to an embodiment of the present disclosure.

FIG. 4 is a schematic diagram showing the measurement of residual noise energy in an ear canal (with and without taking into account ear canal characteristics) according to an embodiment of the present disclosure.

FIG. 5 is a schematic diagram showing a log-power spectrum (LPS) extraction method according to an embodiment of the present disclosure.

FIG. 6 is a schematic diagram showing the ANC reverse wave compensation gain conversion calculation considering the difference in ear canal characteristics according to an embodiment of the present disclosure.

FIG. 7 is a flowchart showing the steps of the ear canal noise reduction compensation method according to the present disclosure.

### DETAILED DESCRIPTION

Implementations of the present disclosure are described below by embodiments. Other advantages and technical effects of the present disclosure can be readily understood by one of ordinary skill in the art upon reading the disclosure of this specification.

It should be noted that the structures, ratios, sizes shown in the drawings appended to this specification are provided in conjunction with the disclosure of this specification in order to facilitate understanding by those skilled in the art. They are not meant, in any ways, to limit the implementations of the present disclosure, and therefore have no substantial technical meaning. Without influencing the effects created and objectives achieved by the present disclosure, any modifications, changes, or adjustments to the structures, ratios, or sizes are construed as falling within the scope covered by the technical contents disclosed herein.

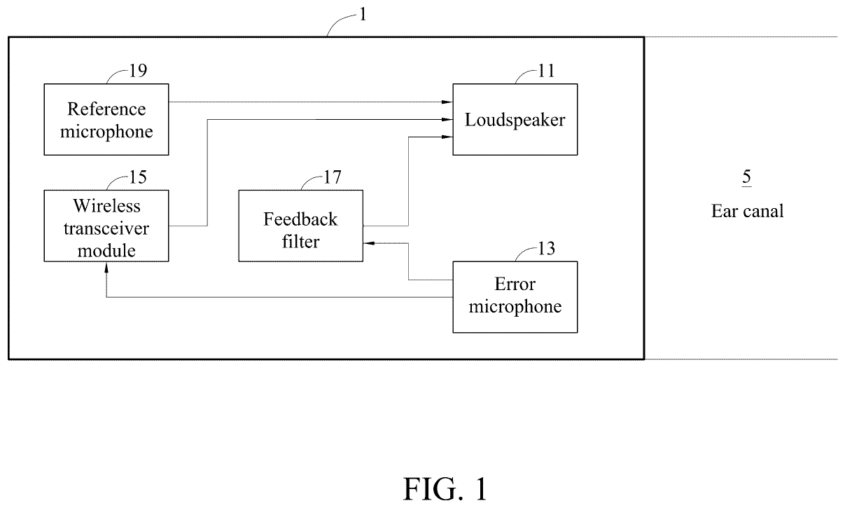

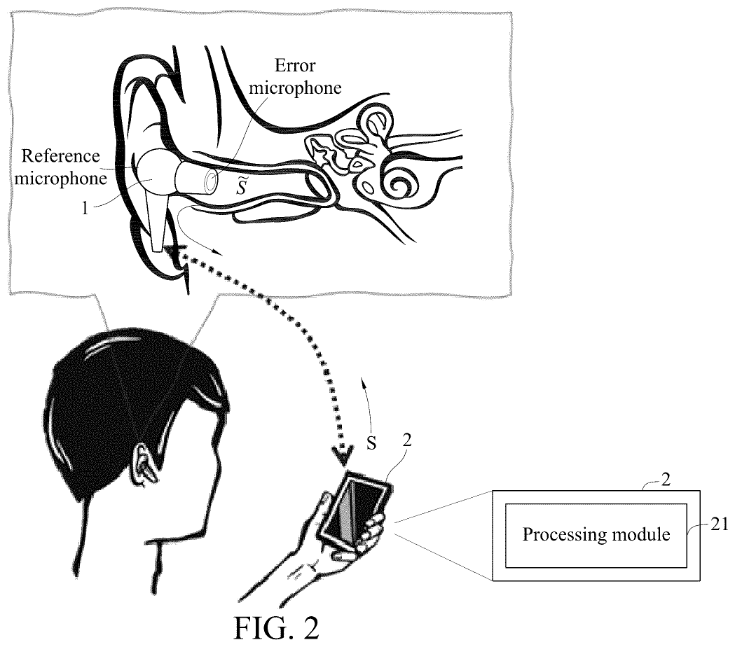

FIG. 1 is a schematic block diagram showing an ear canal noise reduction compensation system and an ear canal 5 according to the present disclosure, and FIG. 2 is a schematic diagram showing an earphone device 1 combined with an electronic device 2 (e.g., a smart device) having a processing module 21 according to an embodiment of the present disclosure.

According to an embodiment of the present disclosure, as shown in FIG. 1 and FIG. 2, the earphone device 1 of the present disclosure includes a loudspeaker 11, an error microphone 13 (e.g., an in-ear microphone), a wireless transceiver module 15 (e.g., a wireless transmission and reception module), a feedback (FB) filter 17 and a reference microphone 19 connected to each other electrically or otherwise. The loudspeaker 11 is driven by audio signal to transmit sound to a user's ear canal 5. The error microphone 13 receives a reflected sound from the user's ear canal 5 to convert the reflected sound into an electrical signal. The wireless transceiver module 15 receives the electrical signal converted from the error microphone 13. The electronic device 2 receives the electrical signal transmitted from the wireless transceiver module 15 via a wireless transmission network.

As shown in FIG. 1 and FIG. 2, the electronic device 2 calculates a difference in sound wave energy between the error microphone 13 and an eardrum (not shown) based on the electrical signal and by means of artificial intelligence technology, generates compensating filter parameters associated with the user's ear canal 5 based on the difference in sound wave energy, transmits the compensating filter parameters to the feedback filter 17 by means of a wireless transmission network (not shown) and the wireless transceiver module 15, and generates compensating energy in a frequency response of reverse waves in the ear canal 5 by means of the compensating filter parameters.

As can be seen from FIG. 1 and FIG. 2 and based on the following, the ear canal noise reduction compensation system of the present disclosure can accurately calculate the energy of the reverse waves on the user's eardrum through the combination of artificial intelligence and acoustic reflection technology by means of the error microphone 13 in the earphone device 1 and the electronic device 2, thereby effectively enhancing the technical efficacy of the active noise cancellation (ANC) framework.

In an embodiment of the present disclosure, the aforesaid audio signal may be a transparency audio signal or a streaming audio signal, and in another embodiment of the present disclosure, the aforesaid audio signal may be an audio signal with a frequency of 3 KHz or less (i.e., from 0 Hz to 3 KHz), but not limited thereto. In addition, the audio signal may be a mixing audio signal.

In an embodiment of the present disclosure, the aforesaid compensating filter parameters are compensating filter parameters of the feedback filter 17 at each frequency of active noise cancellation.

In an embodiment of the present disclosure, the aforesaid feedback filter 17 includes a storage module (not shown). The aforesaid compensating filter parameters are stored in the storage module.

In an embodiment of the present disclosure, the aforesaid feedback filter 17 is a feedback filter module for active noise cancellation.

In an embodiment of the present disclosure, the aforesaid compensating filter parameters may also be transmitted and stored in a device or apparatus having audio processing capability via the wireless transmission network (not shown), and the device or apparatus may generate the compensating energy in the frequency response of the reverse waves in the ear canal 5 by means of the aforesaid compensating filter parameters.

In an embodiment of the present disclosure, as shown in FIG. 1 and FIG. 2, the ear canal noise reduction compensation system of the present disclosure performs real-time and/or synchronous processing via the earphone device 1 and an application program of the electronic device 2 in conjunction with wireless communication technology.

In another embodiment of the present disclosure, the aforesaid compensating filter parameters may be compensating filter parameters of the S (z) or APT filter at each frequency of active noise cancellation.

In addition, the above modules can be software, hardware, or firmware. In the case of hardware, they can be various circuits or hardware units with equivalent technology that implement compensation of feedback filter parameters, wireless transmission and reception, and storage in each frequency, respectively. In the case of software or firmware, they can be various firmware units that implement compensation of feedback filter parameters, wireless transmission and reception, and storage in each frequency, respectively. The ear canal noise reduction compensation system of the present disclosure includes ANC, but not limited thereto and equivalent technologies are included herein.

With the ear canal noise reduction compensation system of the present disclosure, the user does not need to use an additional probe tube transducer (i.e., probe tube microphone) in order to provide accurate, real-time, automated, and customized earphone devices in real-world environments with the present disclosure and wireless communication technology.

Also, the probe tube transducer is only used to measure the sound wave energy in a standard artificial ear, and the measurement data of the sound wave energy of the standard artificial ear are stored in a database, a cloud server, and/or an electronic device, and the user does not need to use an additional probe tube transducer for the measurement of the sound wave energy of the true ear.

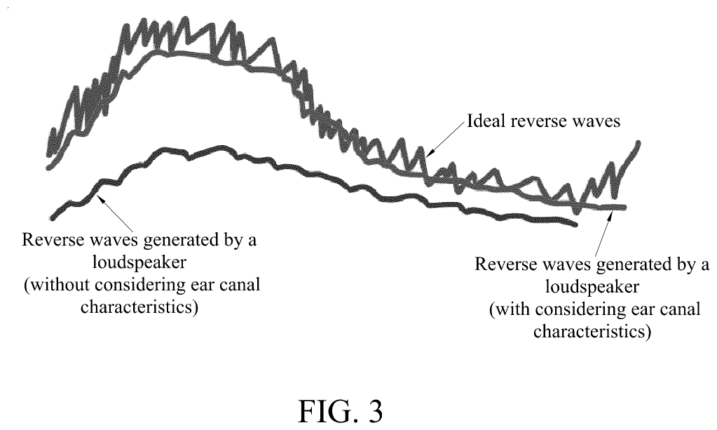

FIG. 3 is a schematic diagram showing the reverse waves with and without consideration of the ear canal characteristics according to the present disclosure. As shown in FIG. 3, the energy and frequency response of the reverse waves without considering the characteristics of the ear canal is still far from the energy and frequency response of the ideal reverse waves, while the energy and frequency response of the reverse waves with considering the characteristics of the ear canal is very similar to the energy and frequency response of the ideal reverse waves.

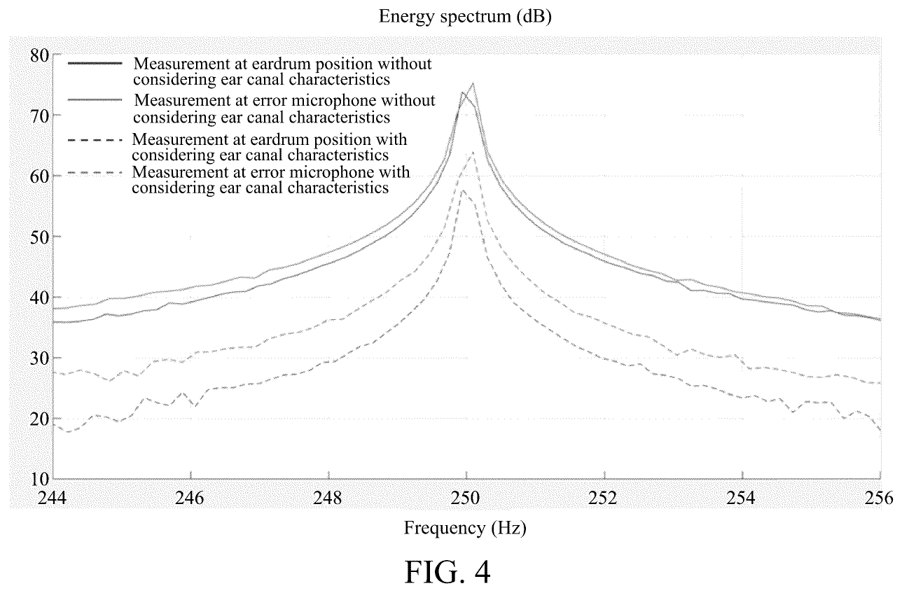

FIG. 4 is a schematic diagram showing the measurement of residual noise energy in an ear canal (with and without taking into account the ear canal characteristics) according to an embodiment of the present disclosure. The Y-axis is in dB and is presented in log, and the X-axis is in Hz and is presented only partially for illustrative purposes.

FIG. 4 compares two scenarios: one case where the ear canal characteristics are not considered (indicated by solid lines), and the other case where the method of the present disclosure is applied to consider the ear canal characteristics (indicated by dotted lines). In both cases, measurements are taken at the eardrum position (black line) and at the error microphone position (gray line), respectively. A lower dB value represents a better noise reduction effect. It can be clearly observed from FIG. 4 that, whether it is the measurement result of the eardrum position (black dotted line vs. black solid line) or the measurement result of the error microphone position (gray dotted line vs. gray solid line), the residual noise energy using the method of the present disclosure that takes into account the characteristics of the ear canal (dotted line) is significantly lower than the case where the characteristics of the ear canal are not considered (solid line). The data confirms that the method of considering the characteristics of the user's ear canal proposed by the present disclosure is effective in improving the active noise cancellation performance and achieving a more excellent ear canal noise reduction effect.

Accordingly, as can be seen from FIG. 4, the residual noise energy considering the ear canal characteristics is much lower than the residual noise energy not considering the ear canal characteristics, and the residual noise energy measured at the eardrum position is lower than the residual noise energy measured by the error microphone. Therefore, the ear canal noise reduction compensation system of the present disclosure can accurately calculate the reverse wave energy on the user's eardrum through the earphone device and the electronic device combined with artificial intelligence and acoustic reflection technology, thereby effectively strengthening the technical effect of the active noise cancellation framework/architecture.

The following describes the calculation of the frequency response of the electrical signal S and the calculation of the compensation parameters of the feedback filter via the compensation parameter conversion model.

Calculation of frequency response of electrical signal \tilde{S}:

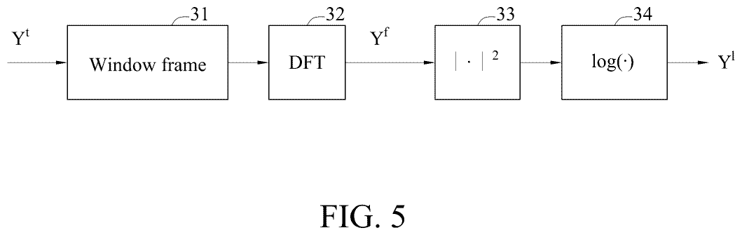

FIG. 5 is a schematic diagram illustrating a log-power spectrum (LPS) extraction method. In an embodiment, the transducer (Err. Mic) first transmits the received electrical signal \tilde{S} to the APP (application program) for acoustic feature extraction, and uses a log-power spectrum (LPS) method to calculate the energy distribution in the electrical signal \tilde{S} over a period of time. When extracting the feature, a short-time Fourier transform (STFT) is performed on the input signal by calculating the discrete Fourier transform (DFT) of each overlapping window frame 31 (e.g., the operation of the discrete Fourier transform is denoted by reference number 32 as shown in FIG. 5), that is, a speech signal is converted from the time domain to the frequency domain via the formula (1), and the formula (1) is presented as follows:

$${Y}^{f} ( k ) = {\sum }_{l = 0}^{L - 1} {Y}^{t} ( l ) h ( l ) {e}^{- j2 π kl / L} \qquad ( 1 )$$

$$k = 0 , 1 , … , L - 1$$

where Y^{t}(l) represents the l-th sample of the input signal (i.e., the electrical signal \tilde{S}) in the time domain, Y^{f}(k) represents the frequency spectrum of the input signal, k is the frequency index, and h(l) represents the Hamming window function. The logarithmic power spectrum is defined as shown in formula (2):

Y^{l}(k)=log |Y^{f}(k)|²

k=0,1, . . . ,K−1 (2)

where Y^{l}(k) represents the logarithmic power spectrum of the input signal, as shown in formula (2), |⋅|² (denoted by reference number 33) is performed on the spectrum Y^{f}(k) of the input signal, and the logarithm (log(⋅)) (denoted by reference number 34) is taken to obtain the logarithmic power spectrum Y^{l}(k) of the electrical signal \tilde{S}.

Performing energy compensation gain parameters of ANC reverse waves via compensation gain conversion model:

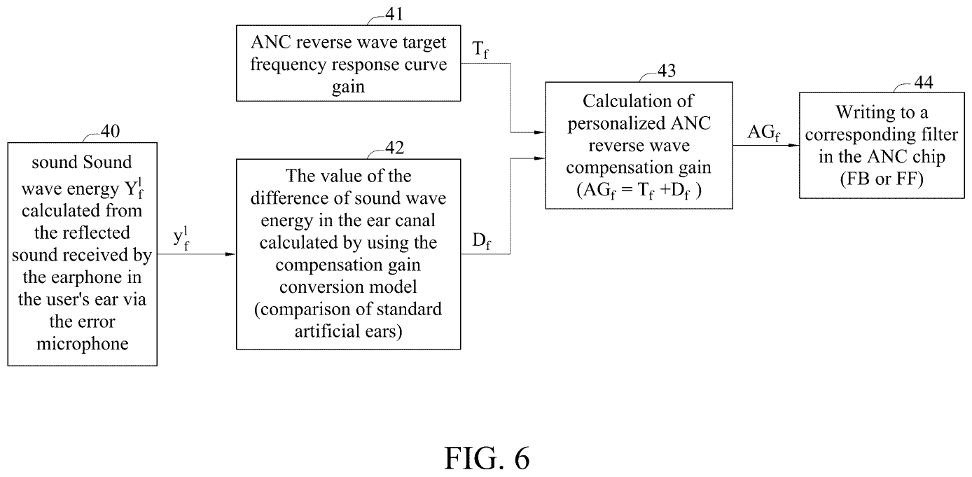

FIG. 6 is a schematic diagram showing the ANC reverse wave compensation gain conversion calculation considering the difference in ear canal characteristics according to an embodiment of the present disclosure. As shown in FIG. 6, the personalized ANC reverse wave compensation gain AG_{f} (denoted by reference number 43) is mainly based on the “ANC reverse wave target frequency response curve gain T_{f} provided by the earphone at the time of manufacturing” (denoted by reference number 41) and the “sound wave energy

$${Y}_{f}^{l}$$

calculated from the reflected sound received by the earphone in the user's ear via the error microphone” (denoted by reference number 40) together with “the value (i.e., Delta value) of the difference of sound wave energy in the ear canal calculated by using the compensation gain conversion model” (denoted by reference number 42). Accordingly, T_{f} is the target frequency response curve of the reverse waves predicted by the feedforward (FF) and feedback (FB) filters in the ANC chip without considering the characteristics of the user's ear canal. Subsequently, the calculated compensation gain is written to the corresponding FB (or FF) filter in the ANC chip via wireless/wired transmission method/network (denoted by reference number 44), where “f” is the sampling frequency point (Hz), T_{f}, D_{f} and AG_{f} are sound wave energy in dB SPL, and SPL is the sound pressure level.

The compensation gain conversion model calculates the energy (Y′) of the reflected sound received by the error microphone from the mobile phone. Subsequently, the value of the difference in sound wave energy between the user's ear canal and the standard artificial ear (i.e., Delta value) is determined by the personalized ear canal error prediction model (e.g., artificial intelligence algorithms, deep learning methods, machine learning methods, mathematical statistics, etc.), such that the parameter value T_{f} is predicted. The abovementioned processes can be modeled and trained by the compensation gain conversion model framework, and can be realized by the target cost function, as shown in formula (3):

$$L ( {φ}_{NN} ) = \frac{1}{M} {\sum }_{i = 1}^{M} {( {D}_{i , N} - {D}_{i , f} )}^{2} \qquad ( 3 )$$

where N represents a plurality of sets (e.g., N sets) of ANC reverse wave filter gain parameters generated by the model, M represents the number of samples for model training, and i represents the i-th gain data in training.

When the compensation gain conversion model is trained for modeling, the deviation is back-propagated to update the model parameters, and the parameter weights are adjusted to find the optimal compensation, as shown in formula (4):

$${φ}_{NN} = arg {min}_{φ} ( L ( {φ}_{NN} ) ) \qquad ( 4 )$$

In an embodiment of the present disclosure, the earphone device of the present disclosure utilizes active noise cancellation (ANC) technology, but in different embodiments, the same, similar, or equivalent noise cancellation technology may be applied, and the present disclosure is not limited in this regard. In an embodiment, the filter (e.g., FF, FB, SZ, APT, etc.) parameters can be set by the information of “acoustic characteristics of the mechanism” and the “auditory compensation prescription.”

In an embodiment of the present disclosure, the above-mentioned filters may be feedforward (FF) filters, feedback (FB) filters, and audio gain compensation filter units (e.g., S(z) filters, APT filters), respectively. The feedforward (FF) filter receives an electrical signal of the reference microphone to eliminate external noise; the feedback (FB) filter receives an electrical signal of the error microphone (i.e., the error microphone converts the noise in the ear canal into an electrical signal) to eliminate the noise in the ear canal; and the audio gain compensation filter units (e.g., S (z) filters and APT filters) receive appropriate target curves to appropriately adjust the electrical signals in each frequency band.

Since the ear canal noise reduction compensation system of the present disclosure is suitable for various smart devices, the earphone device can perform the compensating filter parameters of the feedback filters in each frequency without the assistance of professionals in the current environment (e.g., in a living room, outdoors, car, park, etc.).

In an embodiment of the present disclosure, the earphone device of the present disclosure may be earphones (including but not limited to dynamic coil type, balanced armature type, piezoelectric type, pneumatic type, electrostatic type, wired transmission, wireless transmission earphones), hearing aids, anti-noise earphones, monitoring earphones, smart glasses, wearable devices, or a combination thereof.

In addition, the ear canal noise reduction compensation system of the present disclosure can directly synchronize the user's real-time customized parameter compensation to the noise cancellation module arranged in the same or single chip by combining a compensation parameter conversion model with wireless communication technology (e.g., Bluetooth, Wi-Fi, near-field communication (NFC), ultra-wideband (UWB), IEEE 802.15.4, and other wireless communication technologies).

Moreover, according to the above-mentioned embodiments of the present disclosure, the user may use his or her own devices (e.g., various smart devices in conjunction with ANC earphones or TWS earphones) to perform compensation of parameters of the feedback filters at each frequency in a variety of current real environments or real application environments (i.e., quiet or noisy environments).

In an embodiment of the present disclosure, the earphone device of the present disclosure does not need to be confined to an audiometric testing room and does not require professional assistance, and the user does not need to use an additional probe tube transducer, but the present disclosure can automatically and instantly customize the user's earphone device by his or her own devices (e.g., earphone devices, hearing aids, auditory aids, etc.) and by an electronic device (e.g., a smart device) in combination with a compensation parameter conversion model and wireless communication technology.

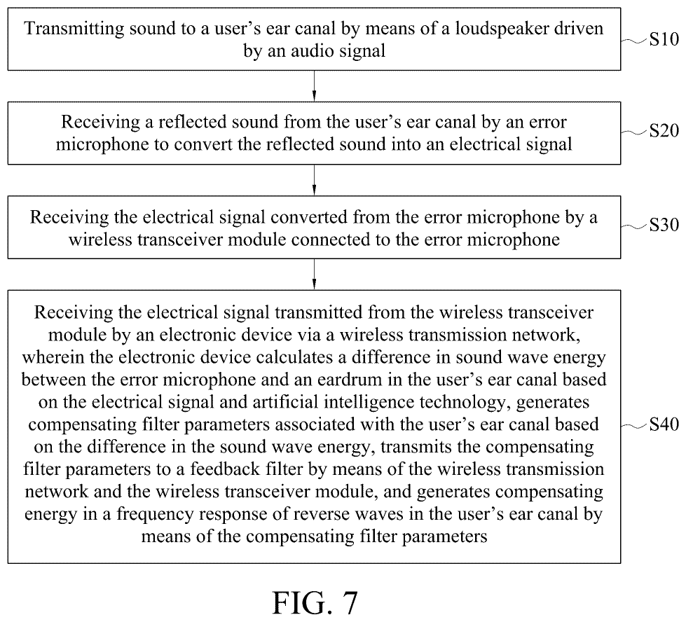

FIG. 7 is a flowchart showing the steps of the ear canal noise reduction compensation method according to the present disclosure, and FIG. 7 is illustrated in conjunction with the description of the above-mentioned embodiments, wherein the compensation method at least includes the following steps S10 to S40.

In step S10, sound is transmitted to a user's ear canal by means of a loudspeaker driven by an audio signal.

In step S20, a reflected sound is received from the user's ear canal by an error microphone to convert the reflected sound into an electrical signal.

In step S30, the electrical signal converted from the error microphone is received by a wireless transceiver module connected to the error microphone.

In step S40, the electrical signal transmitted from the wireless transceiver module is received by an electronic device via a wireless transmission network, wherein the electronic device calculates a difference in sound wave energy between the error microphone and an eardrum in the user's ear canal based on the electrical signal and artificial intelligence technology, generates compensating filter parameters associated with the user's ear canal based on the difference in the sound wave energy, transmits the compensating filter parameters to a feedback filter by means of the wireless transmission network and the wireless transceiver module, and generates compensating energy in a frequency response of reverse waves in the user's ear canal by means of the compensating filter parameters.

In the compensation method described above, the feedback filter is disposed in the active noise cancellation (ANC) chip of the earphone device.

In addition, in an embodiment of the present disclosure, the ANC technology has been gradually applied to TWS earphones in the audio processing chips, in which the reverse wave signals are generated by the hardware circuits and corresponding system parameters to achieve the function of active noise cancellation. Since ANC technology is capable of extremely low delay time (<20 μs), the processing thereof with extremely high sampling rate is also used to solve the challenge of delay time in addition to the advantages implementing by hardware circuits. Therefore, in the ANC technology framework, the present disclosure is able to appropriately and correctly compensate the filter parameters with the feedback filter.

In summary, the ear canal noise reduction compensation system (which includes an earphone device and an electronic device) and the ear canal noise reduction compensation method of the present disclosure are based on the active noise cancellation (ANC) technology combined with the digital network technology and wireless transmission technology. The present disclosure not only directly compensate the appropriate gain in each frequency, but also enables the earphone device to accurately emit the same reverse wave (including consideration of ear canal characteristics) as the current noise energy (which includes the signal resonating in the ear canal when the user speaks, i.e., the interference generated by the own voice and leakage noise), so as to effectively cancel the ambient noise in the ear canal. The present disclosure has the effect of automating, instantly and customizing a user's earphone device, such that the user's earphone device can listen to a clearer sound or better-sounding music.

In addition, the earphone device, the electronic device, and the ear canal noise reduction compensation system and method thereof of the present disclosure achieve the effect of automated, real-time, and customization of the user's earphone device by taking into account the ear canal characteristics of the user's frequency response through the compensation parameter conversion modeling technique, so as to enable the user's earphone device to listen to clearer sound or better-sounding music.

Moreover, in an embodiment of the present disclosure, the compensation parameter conversion model may also automatically correct the compensating filter parameters of the feedback filter of the earphone device. The compensation parameter conversion model may be disposed in an earphone device, a smart device, a cloud, or a server, and the present disclosure is not limited thereto.

Further, the earphone device, the electronic device, and the ear canal noise reduction compensation system and method thereof of the present disclosure are free from requiring a dynamic range compression function (DRCF) and do not require dynamic adjustment of the parameters of the feedback filter.

In addition, in an embodiment of the present disclosure, the present disclosure provides a computer program product that performs one or more of the above methods by means of a program loaded into a computer. The computer program (product) may be stored in a recording medium or may be provided by direct transmission over a network, i.e., the computer program (product) is an object containing a program that can be accessed by a computer and is not limited to an external form. The computer includes, but not limited to, an electronic device with a processor, such as a server, etc. Furthermore, the computer program product of the present disclosure utilizes the technical content of the said device (compensation parameter conversion model, etc.) or firmware, software technology thereof to perform the aforementioned content, and can automatically store the feedback filter compensating parameters into the storage module of the feedback filter.

The present disclosure also provides a computer-readable recording medium for use in a computing device or computer having a processor and/or memory, and the computer-readable recording medium stores instructions and can be utilized by the computing device or computer to execute the computer-readable recording medium by the processor and/or memory in order to perform the aforementioned method and/or content when executing the computer-readable recording medium. The computer-readable recording medium (e.g., hard disk, floppy disk, optical disk, Universal Serial Bus [USB] flash drive) stores the computer program (product). In an embodiment, the computer-readable recording medium is a non-transitory computer-readable recording storage medium.

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. Therefore, the scope claimed of the present disclosure should be defined by the following claims.

What is claimed is:

1. An ear canal noise reduction compensation system, comprising:
a loudspeaker driven by an audio signal to transmit sound to a user's ear canal;
an error microphone receiving a reflected sound from the user's ear canal to convert the reflected sound into an electrical signal;
a wireless transceiver module receiving the electrical signal converted from the error microphone; and
an electronic device receiving the electrical signal transmitted from the wireless transceiver module via a wireless transmission network,
wherein the electronic device calculates a difference in sound wave energy between the error microphone and an eardrum in the user's ear canal based on the electrical signal and artificial intelligence technology, generates compensating filter parameters associated with the user's ear canal based on the difference in the sound wave energy, transmits the compensating filter parameters to a feedback filter by means of the wireless transmission network and the wireless transceiver module, and generates compensating energy in a frequency response of reverse waves in the user's ear canal by means of the compensating filter parameters.

2. The ear canal noise reduction compensation system of claim 1, wherein the audio signal is a transparency audio signal or a streaming audio signal.

3. The ear canal noise reduction compensation system of claim 1, wherein the audio signal is an audio signal with a frequency of 3 KHz or less.

4. The ear canal noise reduction compensation system of claim 1, wherein the feedback filter includes a storage module, and the compensating filter parameters are stored in the storage module.

5. The ear canal noise reduction compensation system of claim 1, wherein the feedback filter is a feedback filter module for active noise cancellation.

6. The ear canal noise reduction compensation system of claim 1, wherein the compensating filter parameters are transmitted to and stored in a device or an apparatus having audio processing capability via the wireless transmission network, and the device or the apparatus generates the compensating energy in the frequency response of the reverse waves in the user's ear canal by means of the compensating filter parameters.

7. The ear canal noise reduction compensation system of claim 1, wherein the ear canal noise reduction compensation system performs real-time and/or synchronous processing via an earphone device and an application program of the electronic device in conjunction with wireless communication technology.

8. An ear canal noise reduction compensation method, comprising:
transmitting sound to a user's ear canal by means of a loudspeaker driven by an audio signal;
receiving a reflected sound from the user's ear canal by an error microphone to convert the reflected sound into an electrical signal;
receiving the electrical signal converted from the error microphone by a wireless transceiver module connected to the error microphone; and
receiving the electrical signal transmitted from the wireless transceiver module by an electronic device via a wireless transmission network,
wherein the electronic device calculates a difference in sound wave energy between the error microphone and an eardrum in the user's ear canal based on the electrical signal and artificial intelligence technology, generates compensating filter parameters associated with the user's ear canal based on the difference in the sound wave energy, transmits the compensating filter parameters to a feedback filter by means of the wireless transmission network and the wireless transceiver module, and generates compensating energy in a frequency response of reverse waves in the user's ear canal by means of the compensating filter parameters.

9. The ear canal noise reduction compensation method of claim 8, wherein the audio signal is a transparency audio signal or a streaming audio signal.

10. The ear canal noise reduction compensation method of claim 8, wherein the audio signal is an audio signal with a frequency of 3 KHz or less.

11. The ear canal noise reduction compensation method of claim 8, wherein the feedback filter includes a storage module, and the compensating filter parameters are stored in the storage module.

12. The ear canal noise reduction compensation method of claim 8, wherein the feedback filter is a feedback filter module for active noise cancellation.

13. The ear canal noise reduction compensation method of claim 8, wherein the compensating filter parameters are transmitted to and stored in a device or an apparatus having audio processing capability via the wireless transmission network, and the device or the apparatus generates the compensating energy in the frequency response of the reverse waves in the user's ear canal by means of the compensating filter parameters.

14. The ear canal noise reduction compensation method of claim 8, wherein the ear canal noise reduction compensation system performs real-time and/or synchronous processing via an earphone device and an application program of the electronic device in conjunction with wireless communication technology.

15. A computer program product implementing the ear canal noise reduction compensation method of claim 8.
